(19) United States
(12) Patent Application Publication
(10) Pub. No.: US 2026/0154365 A1
(43) Pub. Date: Jun. 4, 2026

(54) System and Method For Prioritizing Content Strategy Based on user Goals and Feasibility

(71) Applicant: Daniel Kaman, Brooklyn, NY (US)

(72) Inventor: Daniel Kaman, Brooklyn, NY (US)

(21) Appl. No.: 18/964,777

(22) Filed: Dec. 2, 2024

(51) Int. Cl. G06F 16/958; G06Q 30/0242

(52) U.S. Cl. CPC G06F 16/958; G06Q 30/0244; G06Q 30/0246

(57) ABSTRACT

An SEO tool for providing data-driven prioritization of content strategies based on user goals or projections based on level of effort taking into account a users constraints and SEO value of their website. The tool comprises proprietary formulas that pull data from APIs to assess how to achieve a users SEO objectives, such as hitting revenue targets, number of leads (or total lead value), traffic value (if your to buy the maximum amount of traffic via Paid Search Ads on Google) or maximizing visibility (traffic opportunity) taking into account the domain authority of site, the competitiveness of the keyword terms targeted and content creation capacity. The tool clusters keywords to identify content sub-themes and themes, determines the values of these themes and filters the results to show what is achievable (not simply what is the most valuable theme).

### BACKGROUND

The present invention relates to the field of search engine optimization (SEO) and, more specifically, to systems and methods for prioritizing content strategy based on user goals and feasibility.

Search engine optimization is a critical component of digital marketing strategies for businesses of all sizes. Effective SEO can drive organic traffic, increase visibility, and ultimately contribute to revenue growth and lead generation. However, aligning SEO efforts with tangible business objectives and determining the most impactful areas to focus on remains a challenge for many organizations.

Existing SEO tools primarily provide data analysis and tracking of key metrics after an SEO strategy has already been implemented. They may identify opportunities for improvement but lack the ability to guide the prioritization of SEO initiatives upfront based on specific user goals and constraints. This can lead to misalignment between SEO work and desired outcomes, inefficient resource allocation, and slower progress toward objectives.

For example, U.S. Patent Application Publication No. 2015/0363401 A1, “Ranking Search Results,” assigned to Google LLC, discloses methods and systems for ranking search results based on the effectiveness of resources in presenting media content related to a specified entity. While this invention addresses the ranking of search results, it does not consider the broader challenge of determining what content to create in the first place to achieve specific SEO goals.

There remains a need for an SEO tool that takes a proactive, goal-oriented approach to prioritizing content strategy. A tool that can either understand a user's goal and provides the level of effort necessary based on that that goal or conversely provide projections based on the level of effort going to be applied. Such a tool could provide data-driven recommendations on the most valuable content themes and keywords to target. This would enable businesses to align their SEO efforts more closely with their objectives, budget efficiently, and accelerate results.

The present invention addresses this need by providing an innovative SEO tool that uses proprietary formulas and data from various APIs to assess how to hit SEO goals and prioritize opportunities based on user inputs. This unique, goal-driven approach to SEO strategy distinguishes the present invention from prior art and offers significant benefits to businesses investing in digital marketing. The final output is a clearly detailed prioritization of content to be updated or created along with SEO optimizations to maximize goal hitting.

### SUMMARY

In an embodiment, the present invention is directed to an SEO tool that provides data-driven prioritization of content strategies based on user goals or projections based on effort and difficulty. The projections can either use the user's real data or data from various APIs. Hereafter both user's goals or projections can be interchangeably referred to as SEO Objectives. The tool uses proprietary formulas to assess how to achieve these specific SEO objectives, such as hitting a target revenue, traffic, leads, visibility or conversely a projection of results for a given domain to prioritize a content plan based on the users SEO objectives.

From the start, The SEO tool pending on how a user answers the initial questions will ultimately provide a plan either how to hit a goal (value) inputted by the user, a projection of traffic is maximum visibility is most important or a projection based on value (not based on Users 1st party data—if the user was to pay to show in Google Ads this would be the cost (or similar Search engine platform) OR based on value the user has inputted (ie. revenue, # leads, lead value, traffic). The SEO tool takes these user inputs, such as website url, revenue, leads, traffic, or visibility. The tool will further request inputs such as average order value, conversion rate, value of a lead, if there is a specific industry and specific geography. Furthermore the tool will ask for additional information if it is available such as a list of keyword to target, keyword ideas/themes, keywords NOT to target, Editorial or website guidelines to follow, or related websites. Lastly, the tool will ask how much content can be/is created on a monthly basis, current domain authority, and content creation bandwidth, and provides clear recommendations on the relatable keywords and the values for each of these keywords. Once there is a derived value (Value meaning Search Volume multiplied by CPC which is the value if you were to pay a search engine for Ads or value based on Search Volume or Real Traffic multiplied by the conversion rate multiplied by the value (of the said lead or sale-revenue) per keyword. The keywords are then clubbed into clusters of keywords called themes and sub-level themes (ex. Finance-Mortgage-Reverse Mortgage). Note when some data is unavailable the SEO tool will pull benchmark data to utilize. From here there is a filtration process to remove keywords and possibly sub-themes and themes that are too difficult to rank. This is conducted by utilizing Domain Authority of a website (extracted from an API source such as Moz) subtract Keyword Difficulty of a site and associate an improvement in ranks based on this difference. The Lucid chart (Section 3) provides more specifics on the table to follow how rank is improved following this methodology.

By aligning SEO efforts with tangible business goals and constraints, the tool enables more efficient resource allocation and accelerates progress toward objectives. It provides a competitive advantage over existing SEO tools that primarily focus on post-hoc analysis by offering upfront, data-driven guidance on prioritization. Providing what it will take to achieve results or projections based on current website and what resources can allocate towards a project are critical to business making decisions not simply a directions based on SEO metrics alone.

The tool's core technology includes formulas that pull data from various APIs to assess how to hit SEO goals or prioritize opportunities not only on factors such as the monetary value of organic traffic, sheer traffic or actual revenue/lead total value by understanding the value of the existing website perceived by Google (& other Search Engines), how much effort are they willing to conduct and how competitive the keywords/themes are. It delivers these recommendations and prioritizes in 1 of four ways: the traffic value (if you were to pay for these terms in Google), the traffic opportunity (based on ranking projection how much traffic will be achieved), value based on revenue or lead value and lastly by showing the level of effort if the user inputting one of the 3 ways just mentioned (traffic value, traffic opportunity, Vale based on revenue or total lead value.

In addition to its goal-oriented approach, the tool offers unique advantages such as clear projections of the resources needed to hit SEO targets and prioritization of content themes based on traffic value or visibility. This can support in understanding how much more effort it will take to hit goal or how much time (how fast) it will take to hit a goal. Furthermore it will prioritize these keywords with correlating pages and ultimately create an SEO Blueprint which this prioritized list is now a content calendar to work from. The tool has the potential for future expansion to provide more holistic SEO strategy and automate SEO strategies and content development processes.

The present invention is targeted toward large small businesses and mid-size companies investing in digital marketing, particularly those with a dedicated marketing director, or a content strategist. Key industries include publishing, e-commerce, finance, education, legal, B2B, beauty/health/wellness and luxury. Use cases vary widely from determining the level of SEO effort needed to hit a revenue goal to identifying untapped content opportunities (new pages or existing pages to refresh the content and the SEO optimizations).

In summary, the present invention addresses a critical gap in the SEO tool market by providing proactive, data-driven prioritization of content strategies based on user goals and constraints. Its innovative approach and unique feature set offer significant benefits to businesses aiming to align their SEO efforts more effectively with their overall objectives.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 illustrates an overview of a system for generating an SEO strategy.

FIG. 2 illustrates a flow diagram of a method for generating an SEO strategy.

FIG. 3 illustrates an exemplary user flow for interacting with the SEO strategy generation system.

FIG. 4 depicts an overview of the user interface for the SEO strategy generation system.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

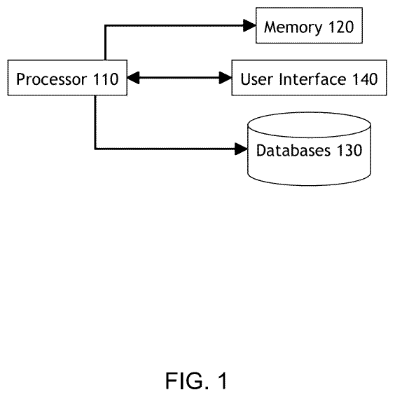

FIG. 1 illustrates an overview of a system 100 for generating an SEO strategy according to an embodiment of the present invention. The system 100 includes a processor 110, a memory 120 storing instructions executable by the processor 110, one or more databases 130, and a user interface 140. The processor 110 may include one or more CPUs, GPUs, APUs, FPGAs, or other hardware processing units. The processor 110 executes instructions stored in the memory 120 to perform the SEO strategy generation process described herein.

The memory 120 may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by the processor 110. The one or more databases 130 store SEO data used by the system 100 to generate the SEO strategy. The SEO data may include but not limited to domain authority, keyword ranking data, page authority, search volumes, cost-per-click values, keyword difficulty scores, cost per click difficulties, click-through-rates, backlink data, conversion rate data, revenue data, lead data (number of leads & value per lead), and competitor data associated with a plurality of keywords. The system will also use technology to determine keywords that should be clubbed together based on page, sub-theme, themes and inter-related themes. The databases 130 may be local to the system 100 or accessed remotely over a network.

The user interface 140 allows a user to interact with the system 100 to initiate the SEO strategy generation process, provide inputs such as a user-defined SEO goal, and view the generated SEO strategy. The user interface 140 may be a graphical user interface (GUI) accessible via a web browser or a dedicated software application. The user interface 140 communicates with the processor 110 to send user inputs and receive outputs for display.

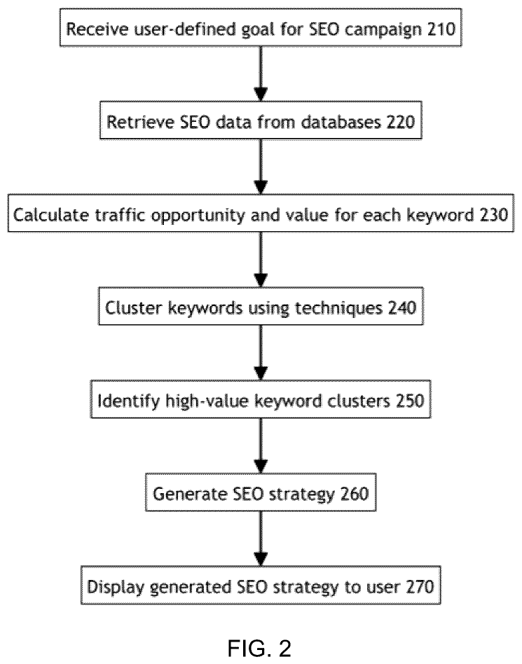

FIG. 2 illustrates a flow diagram of a method 200 for generating an SEO strategy performed by the system 100 according to an embodiment of the invention.

At step 210, the processor 110 receives, via the user interface 140, a user-defined goal for an SEO campaign. The goal may specify a desired keyword ranking, traffic quantity, revenue amount, return-on-investment, or other SEO objective. Some of the questions will be
What's your major objective A. Discoverability/New Visitors or Lead Generation/Sales
Do you have a specific goal to achieve in 1 year? (revenue, leads, traffic, users)
How many pages of content can you create on a monthly basis (optional)?
What industry are you in
What location are you targeting

At step 220, the processor 110 retrieves SEO data from the one or more databases 130. The SEO data includes search volumes, cost-per-click values, keyword difficulty scores, click-through-rates and other metrics associated with a plurality of keywords relevant to the user's website and market. At step 230, the processor 110 calculates a traffic opportunity value and a traffic value for each keyword. The traffic opportunity value is calculated by multiplying the keyword's search volume by the click-through-rate for a top-ranked search result (again either based on 1st party data connected or

benchmark data). The traffic value is calculated by multiplying the search volume by the cost-per-click value (if have first party data then this will substitute the value of cost per click value).

At step 240, the processor 110 uses natural language processing and machine learning techniques to cluster the keywords into semantically related groups. Clustering allows the system to efficiently analyze large keyword sets and target topically related keywords with each content piece, and accordingly bind each content piece into themes and sub-themes.

At step 250, the processor 110 identifies a subset of high-value keyword clusters based on the aggregate traffic opportunity and traffic values of the

keywords in each cluster. These high-value clusters represent the greatest potential to drive qualified traffic and conversions.

At step 260, the processor 110 generates an SEO strategy centered around a content strategy targeting the high-value keyword clusters. The content strategy includes recommendations for the number and type of content pieces to create, what keywords to target, how to semantically optimize the content, what calls-to-action to include, and how to build internal links to the content. These recommendations are based on the user-defined goal, keyword metrics, and competitive gaps. here is a critical step where a filtration process occurs to determine the propensity to improve rank over a period of time taking into account many variables such as domain authority, current rank, competitiveness of keyword, amount of content and links to make this calculation and ‘prioritize’ terms only that will see improvement.

The processor 110 may further enhance the SEO strategy with additional recommendations, such as:
identifying low-competition keyword clusters to target in addition to the high-value clusters;
calculating content and backlink gaps relative to competitors and recommending strategies to close those gaps;
estimating ROI based on traffic and conversion data to prioritize keyword targets;
automatically generating content briefs and optimization recommendations for existing content;
forecasting performance over time and automatically adjusting the strategy based on results; and
scheduling and workflow management for strategy execution.

At step 270, the generated SEO strategy is displayed to the user via the user interface 140. The user can review the strategy, make adjustments to the goal or other parameters, and initiate execution of the strategy. The system and method described above provide a comprehensive, data-driven approach to SEO strategy generation that reduces the time and complexity typically required for manual keyword research, competitive analysis, and content planning. By automating the analysis of large keyword and backlink datasets, and providing specific, actionable recommendations for content creation and link building, the system allows users to efficiently allocate resources to the highest-value SEO opportunities. This will also provide how much content is needed to hit certain goals and thresholds.

The system 100 and method 200 may be implemented using various computing hardware and software. For example, the processor 110 may be a multi-core CPU such as an Intel Xeon or AMD Ryzen processor. The memory 120 may include both volatile RAM and non-volatile storage such as SSDs. The databases 130 may be relational databases such as MySQL, PostgreSQL, or cloud-based databases such as Amazon Aurora or Google Cloud SQL.

The data processing and analysis steps may be implemented using big data technologies such as Apache Spark or Google BigQuery to handle large volumes of SEO data. Machine learning libraries such as TensorFlow, PyTorch, or scikit-learn may be used to implement the keyword clustering, forecasting, and natural language processing functionalities. Word2Vec, GloVe, and BERT can be used to convert keywords into vector representations and determine their semantic relatedness through cosine similarity. Keywords with similar vectors can be clustered using algorithms such as k-means, hierarchical clustering, or even advanced methods like HDBSCAN. Additionally, transformer-based models like BERT provide contextual embeddings for more accurate grouping based on context and relationships. Techniques like Latent Dirichlet Allocation (LDA) and graph-based clustering further identify semantically related clusters by analyzing keyword co-occurrence and community structures in data.

The user interface 140 may be a web-based interface built using front-end frameworks such as React, Angular, or Vue.js. Data visualizations may be created using libraries such as D3.js or Chart.js. The backend server application may be built using frameworks such as Express.js (Node.js) or Django (Python). The system 100 may be deployed on cloud computing platforms such as Amazon Web Services, Google Cloud Platform, or Microsoft Azure to provide scalability and high availability. Containerization technologies such as Docker may be used to package the application components and streamline deployment.

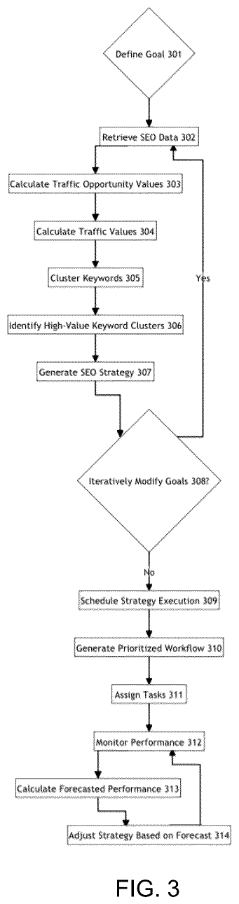

FIG. 3 illustrates an exemplary user flow for interacting with the SEO strategy generation system. The user flow begins with the user defining a goal 301 for an SEO campaign via a user interface. The user-defined goal 301 may comprise increasing organic traffic, leads, sales, revenue, ranked keywords, or share of voice relative to competitors. The system receives the user-defined goal 301 and retrieves SEO data 302 from one or more databases.

The SEO data 302 includes search volumes, cost-per-click values, keyword difficulty scores, and click-through rates associated with a plurality of keywords. The system then calculates traffic opportunity values 303 and traffic values 304 for each keyword by multiplying search volume by click-through rate and cost-per-click respectively. Keywords are clustered 305 based on semantic similarity and high-value keyword clusters 306 are identified based on aggregate traffic opportunity and traffic values. An SEO strategy 307 is generated comprising a content strategy targeting the high-value keyword clusters 306. The content strategy includes recommendations for content creation and link building and may display associated costs on the user interface.

The user can iteratively modify goals 308 via the user interface, triggering the system to re-calculate traffic values, re-identify high-value clusters, and update the SEO strategy. The SEO strategy is automatically scheduled 309 for execution over a time period, a prioritized workflow of tasks is generated 310, and tasks are assigned 311 to users.

Performance of the executing SEO strategy is monitored 312 based on organic traffic and ranking data. Forecasted performance is calculated 313 based on monitored data and the SEO strategy is automatically adjusted 314 based on the forecast.

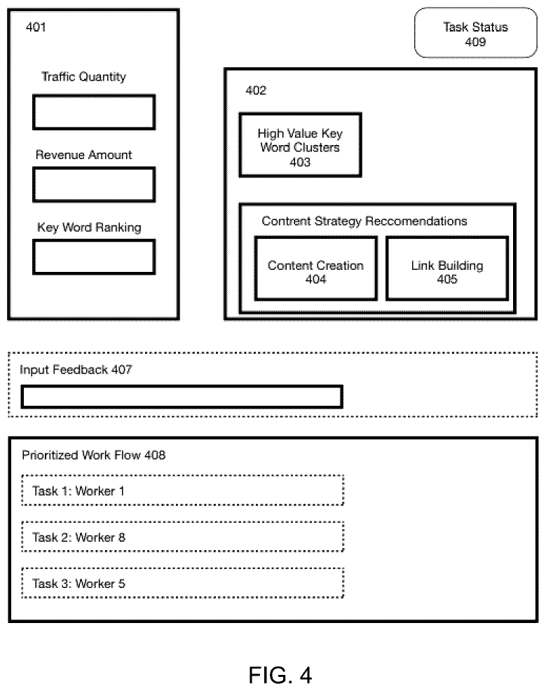

FIG. 4 depicts an overview of the user interface 140 for the SEO strategy generation system. The user interface 140 includes a goal definition panel 401 where the user can input and modify SEO campaign goals such as specifying a target keyword ranking, traffic quantity, revenue amount, or ROI. The user interface 140 displays the generated SEO strategy 402 including the high-value keyword clusters 403 identified by the system. The content strategy recommendations for content creation 404 and link building 405 are displayed. For each recommendation, the user interface 140 may display an associated cost 406 for implementation, such as content creation costs and link acquisition costs. The costs 406 are calculated by the system based on the nature and volume of content and links recommended. The user interface 140 allows the user to input feedback 407 on the SEO strategy and modify goals. When the user modifies a goal via the goal definition panel 401, the system re-calculates keyword traffic values, re-identifies high-value keyword clusters, and updates the SEO strategy 402 and recommendations 404, 405 displayed on the interface. The user interface 140 also displays the automatically generated prioritized workflow 408 of SEO tasks and allows the user to assign tasks to team members for completion. As the assigned tasks are completed, the user interface 140 updates to reflect task status 409. The user interface 140 may be implemented as a web-based interface using HTML, CSS and JavaScript, a mobile app interface using Java or Swift, or as a desktop application interface using frameworks like Electron or Qt. This will also provide a clear plan of number of content and prioritization of all content based on highest propensity for results as determined by user.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A computer-implemented method for generating a content marketing and search engine optimization strategy, the method comprising:
receiving, by a processor, a user-defined goal for an SEO campaign;
retrieving, from one or more databases, SEO data comprising search volumes, cost-per-click values, keyword difficulty scores, and click-through-rates associated with a plurality of keywords;
calculating, by the processor, a traffic opportunity, for each of the plurality of keywords by multiplying the search volume by the click-through-rate for a top-ranked search result;
calculating, by the processor, a traffic value for each of the plurality of keywords by multiplying the search volume by the cost-per-click value;
clustering, by the processor, the plurality of keywords into a plurality of keyword clusters based on semantic similarity;
identifying, by the processor, a subset of high-value keyword clusters from the plurality of keyword clusters based on an aggregate traffic opportunity value and an aggregate traffic value associated with each keyword cluster; and
generating, by the processor, an SEO strategy comprising a content strategy targeting the subset of high-value keyword clusters, wherein the content strategy includes recommendations for content creation and link building based on the user-defined goal, the traffic opportunity values, the traffic values, and the keyword difficulty scores. This process changes if the user has input all their own information where by if the user inputs a target goal ex. 10,000 visitors the toll will compute what level of work will need to be done to hit this goal and prioritize work to hit this goal. If a specific goal is not provided by user but the user does provide first party data then traffic opportunity and traffic value is based on 1st party data. This is done by using actual click through rates, actual traffic for traffic opportunities and actual lead/sales and conversion rate data for traffic value.

2. The method of claim 1, further comprising:
calculating, by the processor, a content gap score for each of the plurality of keyword clusters by comparing a number of existing content pieces targeting each keyword cluster to an average number of content pieces published by one or more competitors targeting the same keyword cluster; and
wherein generating the SEO strategy further comprises recommending a number of new content pieces to create for each of the subset of high-value keyword clusters based on the content gap scores.

3. The method of claim 1, further comprising:
identifying, by the processor, a subset of low-competition keyword clusters from the plurality of keyword clusters based on the keyword difficulty scores; and
wherein generating the SEO strategy further comprises allocating a portion of the content strategy to targeting the subset of low-competition keyword clusters. Ultimately the system minimizes the amount of work needed to be conducted by prioritized pages that will get the most traffic or value based on improvement in rank taking into account what the projected rank improvement will be.

4. The method of claim 1, further comprising:
retrieving, from the one or more databases, backlink data indicating quantities of backlinks pointing to a website of the user and to one or more websites of competitors;
calculating, by the processor, a backlink gap for each of the subset of high-value keyword clusters by comparing the quantity of backlinks pointing to the user's website and associated with each high-value keyword cluster to an average quantity of backlinks pointing to the competitors'websites and associated with the same high-value keyword cluster; and
wherein generating the SEO strategy further comprises recommending a number of new backlinks to build for each of the subset of high-value keyword clusters based on the backlink gaps.

5. The method of claim 1, further comprising:
retrieving, from the one or more databases, conversion rate data and revenue data associated with the plurality of keywords;
calculating, by the processor, an estimated return on investment (ROI) value for each of the plurality of keyword clusters based on the conversion rate data, the revenue data, the traffic opportunity values, and the traffic values; and
wherein identifying the subset of high-value keyword clusters is further based on the estimated ROI values.

6. The method of claim 1, further comprising:
automatically generating, by the processor, one or more content briefs for the content strategy, each content brief providing guidelines and requirements for a piece of content optimized to target one or more of the high-value keyword clusters.

7. The method of claim 1, further comprising:
automatically identifying, by the processor, one or more existing pieces of content associated with the user that are suitable for optimization based on the SEO strategy;
generating, by the processor, optimization recommendations for each of the one or more existing pieces of content, the optimization recommendations comprising one or more of:
target keywords to include,
semantic-related keywords to include,
length of content,
formatting of content,
calls-to-action to include, and
internal linking opportunities; and
providing the optimization recommendations to the user via a user interface.
This is not simply optimizing existing content but providing the relevant keywords to target for new content to be created as well.

8. The method of claim 1, wherein the user-defined goal comprises one or more of:
increasing organic traffic to a website of the user,
increasing leads or sales generated by the website,
increasing revenue generated by the website,
increasing a quantity of ranked keywords associated with the website, and
increasing the user's share of voice within a market relative to one or more competitors.

9. The method of claim 1, further comprising:
monitoring, by the processor, performance of the SEO strategy over time based on organic traffic data and search engine ranking data gathered from the one or more databases;
calculating, by the processor, a forecasted performance of the SEO strategy based on the monitored performance; and
automatically adjusting, by the processor, the SEO strategy based on the forecasted performance.

10. The method of claim 1, further comprising:
automatically scheduling, by the processor, the SEO strategy for execution over a predetermined time period;
automatically generating, by the processor, a workflow for executing the SEO strategy, the workflow comprising a prioritized set of tasks; and
automatically assigning, by the processor, the prioritized set of tasks to one or more users for completion.

11. The method of claim 1, further comprising calculating, by the processor, costs for content creation and link building based on the SEO strategy, and presenting these costs to the user.

12. A system for generating a search engine optimization strategy, the system comprising:
a processor;
a memory storing instructions that, when executed by the processor, cause the system to:
receive a user-defined goal for an SEO campaign;
retrieve, from one or more databases, SEO data comprising search volumes, cost-per-click values, keyword difficulty scores, and click-through-rates associated with a plurality of keywords;
calculate a traffic opportunity value for each of the plurality of keywords by multiplying the search volume by the click-through-rate for a top-ranked search result;
calculate a traffic value for each of the plurality of keywords by multiplying the search volume by the cost-per-click value;
cluster the plurality of keywords into a plurality of keyword clusters based on semantic similarity;
identify a subset of high-value keyword clusters from the plurality of keyword clusters based on an aggregate traffic opportunity value and an aggregate traffic value associated with each keyword cluster; and
generate an SEO strategy comprising a content strategy targeting the subset of high-value keyword clusters, wherein the content strategy includes recommendations for content creation and link building based on the user-defined goal, the traffic opportunity values, the traffic values, and the keyword difficulty scores; and
a user interface configured to display the generated SEO strategy.

13. The system of claim 12, wherein the instructions further cause the system to:
retrieve competitor SEO data associated with one or more competitors;
identify content gaps between the competitor SEO data and the SEO data; and
generate additional content recommendations in the SEO strategy to address the identified content gaps.

14. The system of claim 12, wherein the instructions further cause the system to:
calculate a content creation cost for implementing the content strategy based on the recommendations for content creation;
calculate a link building cost for implementing the content strategy based on the recommendations for link building; an
display the content creation cost and the link building cost in the user interface

15. The system of claim 12, wherein the instructions further cause the system to:
receive, via the user interface, a modification to the user-defined goal;
re-calculate the traffic opportunity values and the traffic values for each of the plurality of keywords based on the modification to the user-defined goal;
re-identify the subset of high-value keyword clusters based on the re-calculated traffic opportunity values and traffic values; an
update the SEO strategy based on the re-identified subset of high-value keyword clusters

16. The system of claim 12, wherein the content strategy further includes recommendations for:
a number of new pieces of content to be created;
one or more content formats for the new pieces of content a number of internal links to include in each of the new pieces of content; an
a number of external links to obtain for each of the new pieces of content

17. The system of claim 12, wherein the instructions further cause the system to:
assign each of the plurality of keywords to one of a plurality of search intent categories; and
generate the content strategy based further on the search intent categories assigned to the subset of high-value keyword clusters.

18. The system of claim 12, wherein the instructions further cause the system to:
retrieve competitor backlink data for one or more competitors;
identify a subset of competitor backlinks from the competitor backlink databased on a domain authority metric; an
generate additional link building recommendations in the SEO strategy to target websites associated with the subset of competitor backlinks

19. The system of claim 12, wherein the user-defined goal comprises one of:
a specified keyword ranking for one or more of the plurality of keywords;
a specified traffic quantity;
a specified revenue amount; or
a specified return-on-investment.

20. The system of claim 12, wherein the instructions further cause the system to:
calculate a content gap score for each of the plurality of keyword clusters by comparing a number of existing content pieces targeting each keyword cluster to an average number of content pieces published by one or more competitors targeting the same keyword cluster; and
wherein generating the SEO strategy further comprises recommending a number of new content pieces to create for each of the subset of high-value keyword clusters based on the content gap scores.

21. The system of claim 12, wherein the instructions further cause the system to:
identify a subset of low-competition keyword clusters from the plurality of keyword clusters based on the keyword difficulty scores; and
wherein generating the SEO strategy further comprises allocating a portion of the content strategy to targeting the subset of low-competition keyword clusters.

22. The system of claim 12, wherein the instructions further cause the system to:
retrieve, from the one or more databases, backlink data indicating quantities of backlinks pointing to a website of the user and to one or more websites of competitors;
calculate a backlink gap for each of the subset of high-value keyword clusters by comparing the quantity of backlinks pointing to the user's website and associated with each high-value keyword cluster to an average quantity of backlinks pointing to the competitors'websites and associated with the same high-value keyword cluster; and
wherein generating the SEO strategy further comprises recommending a number of new backlinks to build for each of the subset of high-value keyword clusters based on the backlink gaps. Furthermore it will assess the amount of content needed to rank based on how much content can be created on a monthly basis and how much content the top competitors has as well for evaluation.

23. The system of claim 12, wherein the instructions further cause the system to:
retrieve, from the one or more databases, conversion rate data and revenue data associated with the plurality of keywords;
calculate an estimated return on investment (ROI) value for each of the plurality of keyword clusters based on the conversion rate data, the revenue data, the traffic opportunity values, and the traffic values; and
wherein identifying the subset of high-value keyword clusters is further based on the estimated ROI values.

24. The system of claim 12, wherein the instructions further cause the system to:
automatically generate one or more content briefs for the content strategy, each content brief providing guidelines and requirements for a piece of content optimized to target one or more of the high-value keyword clusters.

25. The system of claim 12, wherein the instructions further cause the system to:
monitor performance of the SEO strategy over time based on organic traffic data and search engine ranking data gathered from the one or more databases;
calculate a forecasted performance of the SEO strategy based on the monitored performance; and
automatically adjust the SEO strategy based on the forecasted performance.

26. The system of claim 12, wherein the instructions further cause the system to:
automatically schedule the SEO strategy for execution over a predetermined time period;
automatically generate a workflow for executing the SEO strategy, the workflow comprising a prioritized set of tasks; and
automatically assign the prioritized set of tasks to one or more users for completion.
